(19) United States
(12) Patent Application Publication
(10) Pub. No.: US 2010/0280815 A1
(43) Pub. Date: Nov. 4, 2010

(54) CIRCUIT AND METHOD FOR TESTING ELECTRICALLY CONTROLLABLE POWER SWITCHES FOR ACTIVATING OCCUPANT PROTECTION MEANS

(75) Inventors: Rene Wolf, Schwieberdingen (DE); Thomas Henig, Ditzingen (DE); Hartmut Schumacher, Freiberg (DE); Hermann Maier, Markgroeningen (DE); Jens Wirth, Abstatt (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 12/733,712

(22) PCT Filed: Jul. 22, 2008
(86) PCT No.: PCT/EP2008/059585

§ 371 Date: Jul. 12, 2010

(30) Foreign Application Priority Data
Sep. 17, 2007 (DE) 10 2007 044 345.7

(51) Int. Cl. G06F 17/50

(52) U.S. Cl. 703/18

(57) ABSTRACT

A circuit and a method for testing electrically controllable power switches for activating occupant protection means are proposed. A triggering element for the testing is simulated in that a resistance of this simulation is changed for each of the consecutive time blocks by activating the simulation.

### BACKGROUND OF THE INVENTION

1. Field of the Invention

The present invention relates to a circuit and a method for testing electrically controllable power switches for activating occupant protection means.

2. Description of Related Art

It is already known from published German patent document DE 36 27 239 A1 that a circuit for activating and monitoring triggering circuits in security systems may be implemented. In particular, measures for precise error recognition are proposed.

### BRIEF SUMMARY OF THE INVENTION

The circuit according to the present invention and the method according to the present invention for testing electrically controllable power switches for activating occupant protection means having the features of the independent claims have the advantage in relation thereto that these electrically controllable power switches may be tested easily by simulating the triggering element. This simulation has the advantage that the resistance which this simulation forms may be changed in consecutive blocks by activating the simulation. The dynamic behavior of a triggering element during the powering for activating the occupant protection means may thus be simulated. The triggering element, typically an explosive charge, changes its electrical resistance as a function of time and sometimes also unpredictably. The method according to the present invention and the circuit according to the present invention are particularly suitable for simulating this behavior. The circuit and the method according to the present invention may be implemented in a particularly simple manner.

A circuit is understood in the present case as an electrical circuit made of electrical components. In the present case, testing means that the functionality of the electrically controllable power switches is tested in order to prove their functionality. Various transistor types come into consideration as the electrically controllable power switches, which are able to carry the currents necessary for powering the occupant protection means. Examples of such transistors are bipolar and field effect transistors. Two or three power switches are typically used per triggering circuit; however, it is also possible to use more than three.

In the present case, activating means the deployment of the occupant protection means such as airbags, belt tensioners, crash-active head supports, or active protection means such as an electronic stability program or brakes.

As already defined above, a triggering element is typically to be understood as an explosive charge, which may be produced, for example, by deposition techniques such as sputtering, vapor deposition, etc.

In the present case, the resistance means the electrical resistance of the simulation and thus of this simulation circuit. The simulation circuit has active components which may be activated in order to change the resistance.

Consecutive blocks are to be understood as consecutive time intervals. It is possible that pauses may also be provided between these blocks or the blocks may overlap.

A change in the resistance means that the value of the electrical resistance increases or decreases.

Advantageous improvements of the circuit disclosed in the independent claims and the method disclosed in the independent claims for testing electrically controllable power switches for activating occupant protection means are possible through the measures and refinements listed in the dependent claims.

It is advantageous that the activation is implemented as digital activation. For example, transistor switches may be turned on and off in the simulation, in order to be able to simulate the corresponding changes in the resistance suddenly. This sudden change is also characteristic for the changes of the resistance of a real triggering element as a function of time.

Furthermore, it is advantageous that this digital activation is performed at least partially as a function of random numbers. It is thus ensured that the random change in the triggering element may be simulated very well by the use of such random numbers. This random principle is also applied for the length of the blocks. A mixture of determined changes and random changes may also be provided in the time sequence. These random numbers may be stored in a memory, for example, or they may be generated as a function of a temperature measurement, for example. Other methods for generating these random numbers are also possible.

Furthermore, it is advantageous that the simulation, as indicated above, has at least one first electrically controllable switch. For these switches, which must have very low resistances in the open state in the case of sub-transistors, for example, in the range of a few milliohms, other elements also come into consideration, bipolar or field effect transistors, thyristors, triacs, IGBT, or so-called solid-state relays. Any number of switches is usable in any combination for achieving greatly varying load profiles.

Furthermore, it is advantageous that the simulation has a parallel circuit having at least four branches, the parallel circuit being connected between the two power switches to be tested, and at least one second electrically controllable switch is additionally provided in parallel to one of the two power switches. Through this parallel circuit, a desired or random load profile may be set depending on the activation by corresponding population with electrically controllable switches. By additionally providing a further switch, parallel to at least one of the two power switches, a short-circuit to ground or to the supply voltage or to another point may be simulated.

A particularly advantageous configuration may be seen in that at least one resistor is provided in the first branch of the parallel circuit and at least one third controllable switch is provided in the remaining three branches. This combination has been shown to be particularly suitable for generating the various load profiles for testing the power switches.

Furthermore, it is advantageous that these electrically controllable switches are activatable potential-free.

Exemplary embodiments of the present invention are shown in the drawings and are explained in greater detail in the following description.

### BRIEF DESCRIPTION OF THE SEVERAL VIEWS OF THE DRAWINGS

FIG. 1 shows a block diagram of a control unit for activating occupant protection means having connected components.

FIG. 2 shows a circuit diagram of the circuit according to the present invention.

FIG. 3 shows a time sequence diagram.

FIG. 4 shows a further circuit diagram of the present invention.

FIG. 5 shows a flow chart of the method according to the present invention.

### DETAILED DESCRIPTION OF THE INVENTION

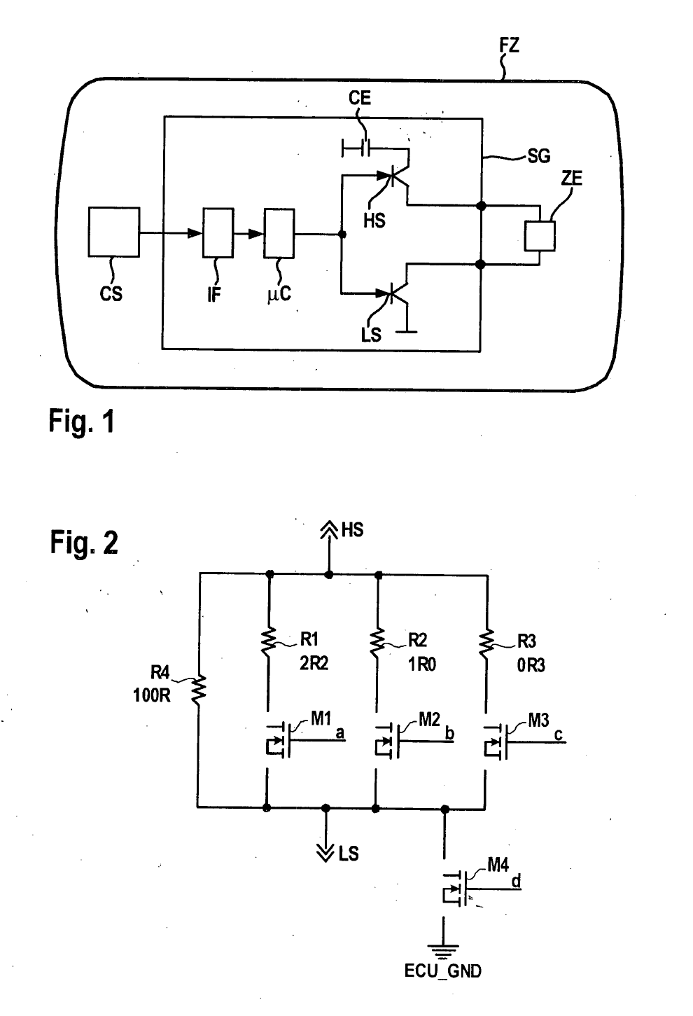

FIG. 1 shows a block diagram of a control unit SG for activating occupant protection means such as airbags or belt tensioners having connected components, namely a crash sensor system CS and a triggering element ZE. Only the components which are required for understanding the present invention are shown as examples here. Further components, such as additional sensors and additional triggering elements, have been omitted for the sake of simplicity. This also applies for the remaining components of control unit SG.

A crash sensor system CS, which includes acceleration sensors, environmental sensors, structure-borne noise sensors, and air pressure sensors, for example, is located in vehicle FZ. This crash sensor system CS, which may be provided concentrated or distributed in the vehicle, transmits its signals via current modulation to an interface IF in control unit SG, for example. This interface IF is implemented in the present case as an integrated circuit. It is possible to simulate it discretely from multiple integrated circuits or from software.

The sensor signals are transmitted to microcontroller μC, which analyzes these crash signals using an analysis algorithm as to whether or not to activate the occupant protection means. If microcontroller μC arrives at the result that the occupant protection means are to be activated, it activates electrically controllable power switches HS and LS via the SPI bus, for example. HS denotes the high side and LS denotes the low side, which is connected to ground. The high side is connected to energy reserve CE, which was charged to a high voltage by a charging circuit. Energy reserve CE, as an electrolytic capacitor, delivers the triggering energy for the triggering of triggering element ZE, which is located outside control unit SG, so that the triggering causes the activation of the particular occupant protection means. For this purpose, switches HS and LS must be closed, so that a current may be caused to flow from the triggering energy in energy reserve CE via triggering element ZE to ground. This triggering has the effect that the triggering element erratically changes its resistance. This means that the way in which the triggering element will change its resistance is hardly predictable; even short-circuits to ground, for example, may occur.

The circuit according to the present invention and the method according to the present invention are intended to simulate such behavior of triggering element ZE. For this purpose, for example, the circuit according to FIG. 2 is proposed. A parallel circuit made up of four branches is connected between high side HS and low side LS, while a further switch M4 is connected to ground on the low side. The parallel circuit has a resistor R4 in the first branch, a transistor switch M1 in the second branch, which is activated by signal a, and a pre-resistor R1. A further transistor switch M2, which is switched by signal b, and a pre-resistor R2 are provided in the third branch. A further transistor switch M3, which is switched by signal c, and a pre-resistor R3 are provided in the fourth branch. Switch M4 is activated by signal d. Switches M1 through 4 are to have a low resistance of a few milliohms in the transmission range. For example, R1 may have 2.2 ohms, R2 1 ohm, R3 0.3 ohms, and R4 100 ohms.

It is possible through time-dependent control of switches M1 through M4 to change the resistance of the parallel circuit rapidly, in particular if digital activation is provided. It is possible to simulate short-circuits to ground through switch M4. However, short-circuits to other potentials may also be simulated. The potential-free activation may be performed by various components, for example, by logic gates, programmable modules, function generators, and microcontrollers. Activation via optocouplers is also possible. The circuit according to the present invention is connected directly to the control unit or to the two power switches.

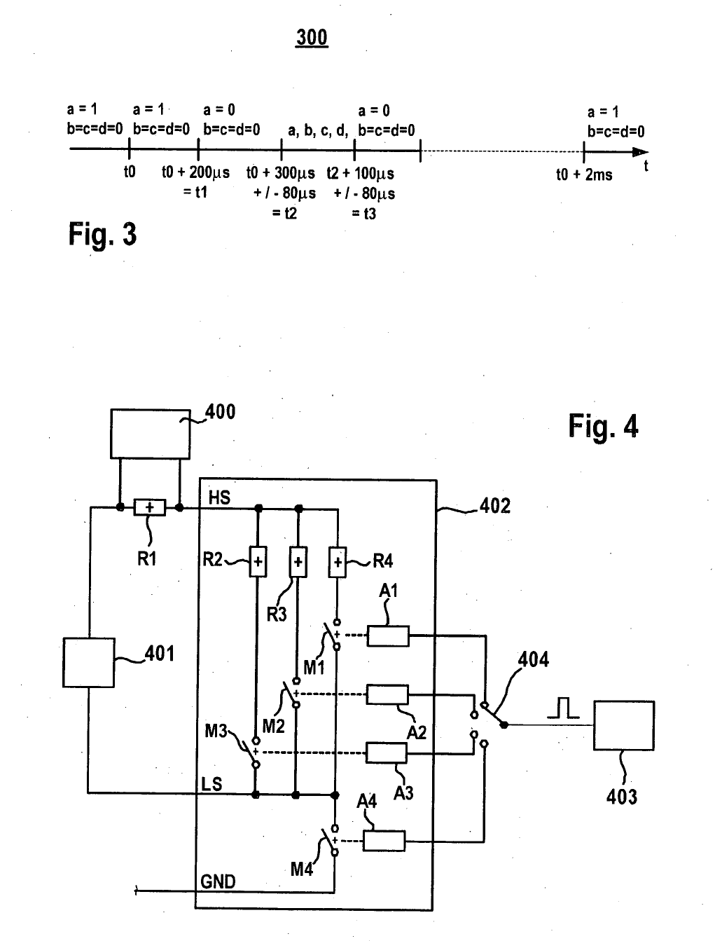

FIG. 3 shows a time sequence of the blocks in order to illustrate the individual phases of the resistance changes of the simulated triggering element.

The initialization of the activation is performed when a voltage difference of greater than approximately 3 V between high side HS and low side LS occurs on the corresponding triggering channel. The method is accordingly automatically initiated, because it is not known at what point in time the triggering of the final stages will occur.

It must be ensured that transistor M1 is low-resistance. This means that it is activated by logical 1, as indicated in FIG. 3 before t0. a, b, c, and d are equal to zero, i.e., switched to “block.” Immediately after the start of triggering procedure t0, i.e., both high side HS and low side LS are activated, the triggering current must flow via M1 for 200 μs, the configuration then goes into the high-resistance state at point in time t1, i.e., a, b, c, and d are at logical zero. The time duration, i.e., the block for which this high resistance is set, is switched for a random time in the range of 200 μs+/−50 μs, the tolerance being able to be predefined variably. After passage of these blocks from an active phase having a setpoint current flow and a subsequent passive phase in which the setpoint current is no longer possible because of the high resistance, further blocks follow. For example, at point in time t0+300 μs, i.e., at point in time t2, at which switching signals a, b, c, and d are determined randomly as a function of random numbers, however, at least one having to be active, i.e., one must be at logical one. A high resistance phase is again provided at point in time t3. This interplay may repeat using different times and different switched-through transistors. More than one may also be active, but at least one is to be active; otherwise there is a high-resistance phase. The random switching of individual signals a, b, c, and d is to be constant for the particular block, however.

The active and passive phases each have a time duration of 100+/−80 μs. The application of the changing resistance to the particular triggering circuit is to last 2 ms on average, so that an average of eight further blocks follow first block 41 until T3.

Transistor M4 randomly connects the final stages to ground with low resistance, in order to simulate a further possible state of the triggering circuit.

FIG. 4 shows a further circuit diagram of the circuit according to the present invention. Circuit 402 is connected to high side HS and low side LS and to ground GND of control unit SG. The circuit according to the present invention has parallel branch R1 having a power supply 401 and resistors R2 and switch M3, resistor R3 and switch M2 and resistor R4 and resistor M1 in the further branches. Switch M4 is again shown parallel to the low side.

Switch M1 is activated by activation unit A1, switch M2 by activation unit A2, switch M3 by activation unit A3, and switch M4 by activation unit A4. These activation units may be implemented potential-free, i.e., for example, as optocouplers.

The pulses generated by a pulse generator 403 reach activation units A1 through A4 via switch 404, optionally also multiple activation units simultaneously, in order to connect through the particular electrical switches of testing circuit 402, M1 through M4. Furthermore, a measuring device 400 is proposed, such as an oscilloscope, which records the voltage via resistor R1 in one channel and records the pulse signal of pulse generator 403 in a further channel. Voltage supply 401 delivers the corresponding supply voltage.

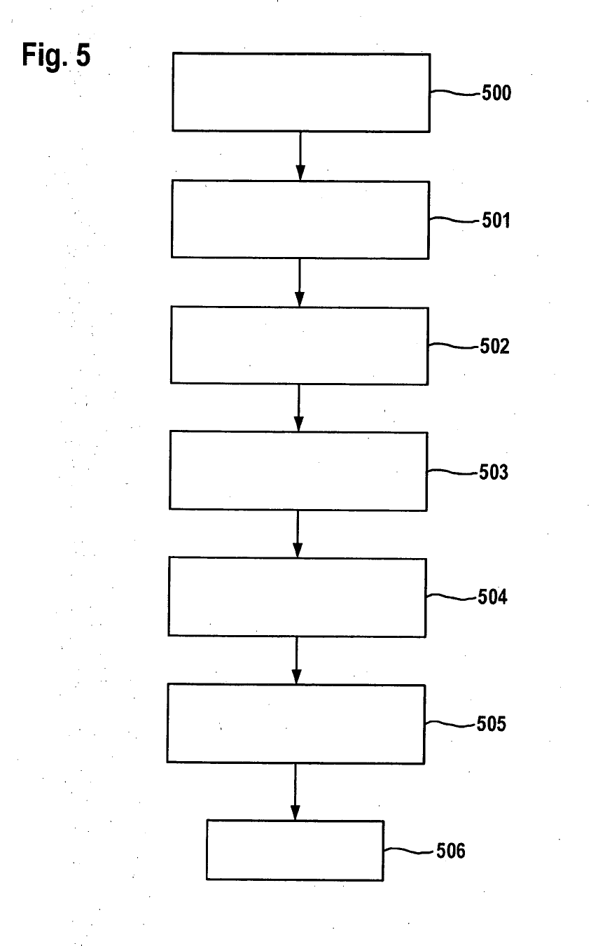

FIG. 5 shows a flow chart of the method according to the present invention. In method step 500 the voltage between high side and low side reaches the 3 V specified above or another value, which is used as the initialization for the method according to the present invention. In method step 501, the triggering current flows via the closed switch M1 for 200 μs. After this setpoint current phase, a high-resistance phase occurs for a random time in method step 502. All transistor switches are blocked. A current phase again follows, at least one of switches M1 through M4 being active and being closed for a random time. This occurs in method steps 503 and 504, a high-resistance phase again, which is also randomly variable in regard to the time length. This may be repeated any number of times, for example, until 2 ms have passed. In method step 505, the triggering current is again conducted via M1, to then end the method in method step 506.

1-10. (canceled)

11. A circuit for testing electrically controllable power switches (HS, LS) for activating occupant protection means (PS), wherein at least one triggering element is simulated for the testing in that a resistance of this simulation is changed by activating the simulation for consecutive time blocks.

12. The circuit as recited in claim 11, wherein the activation is implemented as digital activation.

13. The circuit as recited in claim 12, wherein the digital activation occurs at least partially as a function of random numbers.

14. The circuit as recited in claim 11, wherein the simulation has at least one first controllable electrical switch.

15. The circuit as recited in claim 12, wherein the simulation has at least one first controllable electrical switch.

16. The circuit as recited in claim 13, wherein the simulation has at least one first controllable electrical switch.

17. The circuit as recited in claim 14, wherein the simulation has a parallel circuit having at least four branches, the parallel circuit being connected between the two power switches to be tested, and at least one second electrically controllable switch is provided in parallel to at least one of the two power switches.

18. The circuit as recited in claim 15, wherein the simulation has a parallel circuit having at least four branches, the parallel circuit being connected between the two power switches to be tested, and at least one second electrically controllable switch is provided in parallel to at least one of the two power switches.

19. The circuit as recited in claim 16, wherein the simulation has a parallel circuit having at least four branches, the parallel circuit being connected between the two power switches to be tested, and at least one second electrically controllable switch is provided in parallel to at least one of the two power switches.

20. The circuit as recited in claim 17, wherein at least one resistor is provided in the first branch and at least one third electrically controllable switch is provided in each of the remaining three branches.

21. The circuit as recited in claim 18, wherein at least one resistor is provided in the first branch and at least one third electrically controllable switch is provided in each of the remaining three branches.

22. The circuit as recited in claim 19, wherein at least one resistor is provided in the first branch and at least one third electrically controllable switch is provided in each of the remaining three branches.

23. The circuit as recited in claim 14, wherein the at least one electrically controllable switch is activatable potential-free.

24. The circuit as recited in claim 17, wherein the at least one electrically controllable switch is activatable potential-free.

25. The circuit as recited in claim 20, wherein the at least one electrically controllable switch is activatable potential-free.

26. A method for testing electrically controllable power switches (HS, LS) for activating occupant protection means, comprising simulating at least one triggering element (ZE) for the testing and changing a resistance of the simulation for each consecutive time block by activating the simulation.

27. The method as recited in claim 26, wherein the activation occurs digitally.

28. The method as recited in claim 27, wherein the digital activation occurs at least partially as a function of random numbers.
